(19) United States
(12) Patent Application Publication
(10) Pub. No.: US 2016/0081514 A1
(43) Pub. Date: Mar. 24, 2016

(54) GRILLING FORK HOLDER WITH COMPACT STORAGE MEANS

(71) Applicant: Monty C. Cauble, Warsaw, MO (US)

(72) Inventor: Monty C. Cauble, Warsaw, MO (US)

(21) Appl. No.: 14/493,583

(22) Filed: Sep. 23, 2014

(51) Int. Cl. A47J 33/00; F24B 1/182

(52) U.S. Cl. CPC A47J 33/00; F24B 1/182

(57) ABSTRACT

A compact apparatus for supporting hand-held cooking utensils above a campfire or other such heat source such that there is no requirement for an operator to hold the utensil handle. The apparatus includes an stake that is driven into the ground such that an elongate portion of the stake extends upwardly from the ground. The elongate portion of the stake slidingly receives an elongate utensil holding assembly that extends outwardly from the stake and reversibly engages the utensils. The height of the utensil holding assembly is adjustable and lockable. The utensil holding assembly includes an inner chamber for storing the stake when the apparatus is not in use.

### BACKGROUND OF THE INVENTION

The present invention is directed devices for holding a cooking utensil above a campfire or a grill placed on the ground so that a food item, such as a marshmallow, hotdog or hamburger held by the utensil, can be suspended above the campfire or grill without an operator holding the utensil by hand.

Cooking food over open flames, such as campfires and grills, is a well known cooking method. Food to be cooked that way can be held in a variety of ways, such as in a vessel, such as a pot, dish or wrapping, or on an elongated spit-like utensil, such as a stick, a spit, a skewer, a toasting fork or another food-holding device that prevents the user from being burned while cooking the food. Certain foods, such as marshmallows, hotdogs and hamburgers, are particularly amenable to cooking over an open flame while being held by a utensil with an elongate handle, such as a toasting fork, a wire hotdog holder, a hamburger holder, a fish basket and a wire vegetable basket. For example, many people enjoy toasting marshmallows over a campfire by placing the marshmallows on a stick or a toasting fork and then holding the marshmallow above the fire until browned.

When using such hand-held cooking utensils, the cook must stand or sit next to the fire while the food cooks, which may cause certain problems. For example, the amount of food that can be cooked at one time is limited by the number of utensils the cook can hold. In another example, the cook can be prevented from socializing or performing other tasks, such as preparing the rest of the meal or assisting children.

It is therefore desirable to have a device for hands-free holding one or more hand-held cooking utensils, such as toasting forks, hotdog holders, hamburger holders and the like, above a heat source on the ground, so that the food held on the utensil is suspended above the heat source at a distance that is suitable for cooking the food.

### SUMMARY OF THE INVENTION

In a first embodiment, an utensil holder apparatus is provided for holding an elongated hand-held cooking utensil above the ground, so that food held on the utensil can be mechanically suspended above a heat source on the ground, such as a campfire or a small grill, for hands-free cooking. Suitable utensils include but are not limited to grilling or toasting forks, hotdog holders, hamburger holders, fish holders, vegetable holders and the like that are well known. The apparatus is a two-part device that includes an utensil holding arm assembly and an elongated stake that can be stored within the utensil holding assembly. The stake is partially driven into the ground, such as with a rock or hammer, so that it is in a generally upright orientation. Then the utensil holding arm assembly, which is sized and shaped to reversibly engage a variety of hand-held cooking utensils, is attached to the upper end of the stake so that utensil holding arm assembly is located at a desired height above the ground. In particular, the utensil holding assembly includes a stake engagement subassembly that is received over the stake and then locked in place so that the utensil holding assembly extends over the ground adjacent to the fire.

In an aspect of the first embodiment, the utensil holding assembly includes structure for holding and balancing the utensil on the utensil holding assembly. In particular, the utensil holding assembly includes a cantilever arm with an utensil-engaging surface and a utensil-engaging finger that cooperates a cooking utensil to reversibly engage and hold the utensil. The arm forms a fulcrum for the utensil and the finger counterbalances the portion of the utensil extending toward the heat source and the weight of any food item supplied by the utensil.

In another aspect of the first embodiment, the stake engagement subassembly includes structure for joining the utensil holding assembly and the stake together. The locking mechanism may, for example, be a set screw or bolt which is manually rotated through a threaded nut mounted on the utensil holding assembly to engage a surface of the stake to fix the vertical portion of the utensil holding assembly relative to the ground. This structure may include a through-bore and a locking mechanism. The through-bore is sized and shaped so that the stake can be slidingly received therein or therethrough. When the stake is received in the through-bore, the locking mechanism is actuated, to reversibly engage the stake and thereby fix or set the position of the utensil holding assembly and the stake relative to one another. When this position is set, the distance above of the utensil holding assembly above the ground is also set.

In a further aspect of the first embodiment, the through-bore includes a pair of spaced apart openings that are joined together by an inner surface. The openings are sized and shaped such that the stake can pass through them. The inner surface is shaped so as to be complementary to the stake.

In another aspect of the first embodiment, the locking mechanism includes a lock member and a key member. The lock member is joined with the stake engagement subassembly and reversibly engages the complementary key member.

In a second embodiment, a utensil holding apparatus includes a ground engaging stake that has an elongate shaft and a ground penetrating portion. The ground penetrating portion of the stake is sized and shaped to be driven into the ground, such as by hammering the top end of the stake with a hammer, a rock, or other convenient tool. The ground penetrating portion is driven into the ground so that the shaft extends upwardly from the ground. The apparatus also includes a utensil holding arm assembly with a stake engaging portion, a utensil-engaging surface, and a utensil-engaging finger. The utensil holding assembly is attached to the stake by sliding the stake engaging portion over the stake shaft, so that the stake supports the surface and the finger of the arm assembly above the ground. The surface and the finger cooperate to engage a utensil, whereby the utensil is suspended above the ground. The apparatus also includes a locking assembly that lockingly engages the stake engaging portion and the shaft, so as to releasably lock the stake and the utensil holding assembly together.

In a third embodiment, a method of supporting a utensil above the ground includes driving a first end of a stake into the ground such that a second end of the stake extends upwardly from the ground, engaging a stake engagement assembly with the stake second end such that the stake engagement assembly is positioned above the ground, locking the stake engagement assembly and the stake second end, and then engaging a utensil with a utensil holding assembly extending from the stake engagement assembly, whereby the utensil is suspended above the ground.

In an aspect of the third embodiment, the method includes removing the stake from a storage chamber of the utensil holding assembly prior to driving the stake first end in the ground.

In another aspect of the third embodiment, the method includes sliding the stake engagement assembly along a length of the stake second end so as to adjust the position of the utensil holding assembly above the ground prior to locking the stake engagement assembly and stake second end.

The drawings constitute a part of this specification and include exemplary embodiments of the present invention and illustrate various objects and features thereof.

### BRIEF DESCRIPTION OF THE DRAWINGS

FIG. 1 is a perspective view of a utensil holding apparatus of the instant invention, with the apparatus assembled for use.

FIG. 2 is an enlarged fragmentary top plan view of the apparatus showing the utensil holding assembly holding the handle of an utensil.

FIG. 3 is an enlarged fragmentary front elevational view of the apparatus showing a portion of the stake engaged with the utensil holding assembly, the locking mechanism and three utensil-engaging fingers.

FIG. 4 is an enlarged fragmentary top plan view of the apparatus.

FIG. 5 is an enlarge fragmentary side elevational view of the apparatus and illustrate portions of the compact storage provisions.

FIG. 6 is an enlarged fragmentary cross-section of the apparatus taken on line 6-6 of FIG. 4 and showing the stake stored inside of the utensil holding assembly arm.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIGS. 1-6, the reference numeral 10 denotes a utensil holding apparatus of the instant invention, for mechanically holding a hand-held cooking utensil 12 over a heat source, such as, but not limited to, a campfire 14. Suitable hand-held utensils 12 include, but are not limited to, toasting forks, grilling forks, skewers, hotdog holders, hamburger holders or baskets, fish baskets, vegetable baskets and the like. Such utensils 12 are commonly made of heavy-gauge wire, have elongate handles 16 and may have heat-resistant grips 18. The utensil holding apparatus 10 can also hold some types of sticks (not shown).

The apparatus 10 includes a stake 20 and a utensil holding assembly or arm 22. As shown in FIG. 1, the stake 20 is driven into the ground 24 so that it extends upwardly from the ground 24. The illustrated utensil holding assembly 22 is attached to the stake 20 so that it extends horizontally outwardly in a cantilever manner, away from the stake 20 and is spaced above the ground 24. One or more utensils 12 may be supported by the utensil holding assembly 22 so that the apparatus 10 suspends the utensil 22 above the ground 24 and a campfire 14, or low grilling device such as, but not limited to, a Hibachi grill, or a portable charcoal grill, located on the ground 24 adjacent to or below the utensil holding assembly 22.

The stake 20 is an elongate rod or shaft with a longitudinal axis denoted by A (FIG. 1). The stake 20 is fabricated of a strong, rigid material, such as but not limited to metal, a polymer, wood and combinations thereof. For example, the stake 20 can be fabricated from reinforcement steel (i.e., rebar) or another type of steel rod known in the art. The stake 20 has a circular, oval, or polygonal cross-section, wherein the cross-section is taken perpendicular to the longitudinal axis A.

The stake 20 includes a first portion 26 and a second portion 28. The stake first portion 26 is generally tapered, conical, sharpened, or otherwise shaped for piercing and penetrating the ground 24. For example, the first portion 26 may include a pointed tip 30. The first portion 26 is driven into the dirt 24 by hammering or impacting the top end 31 of the second portion 28 with a hammer, a log, a rock, or a similar hammering tool. When the first portion 26 is driven into the ground 24, a second portion 28 extends upwardly from the ground 24, so that the stake 20 is in an upright orientation. When the first portion 26 is driven a sufficient distance into the ground 24, the second portion 28 can support the utensil holding assembly 22 and any utensils 12 attached to it without bending or falling over.

The utensil holding assembly 22 is fabricated of a strong, fireproof material. Suitable materials include metals, such as, but not limited to, steel, non-flammable polymers, and combinations thereof. The utensil holding assembly 22 includes an elongate body 32 with a longitudinal axis denoted by the letter B (FIG. 3). The body 32 is joined by a stake engagement subassembly 34 at a neck 36 of the assembly 22. The stake engagement subassembly 34 includes a central axis denoted by the letter C (FIGS. 3 and 5). The body axis B is illustrated as being perpendicular to the cross member axis C (FIG. 3).

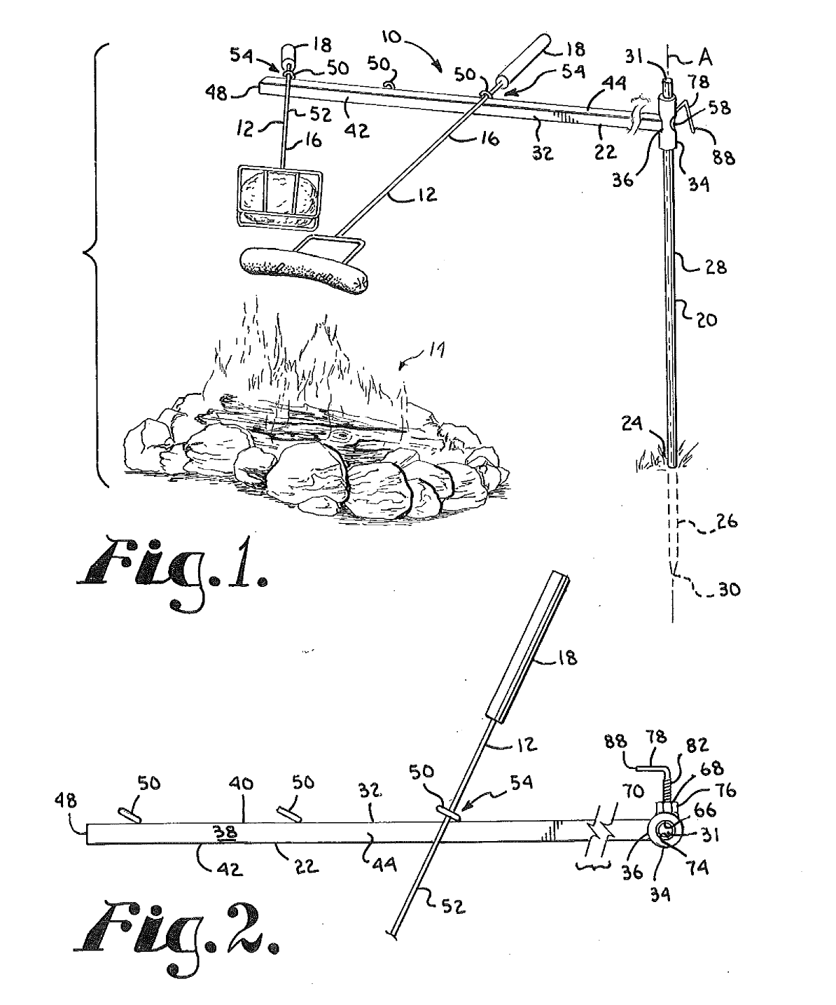

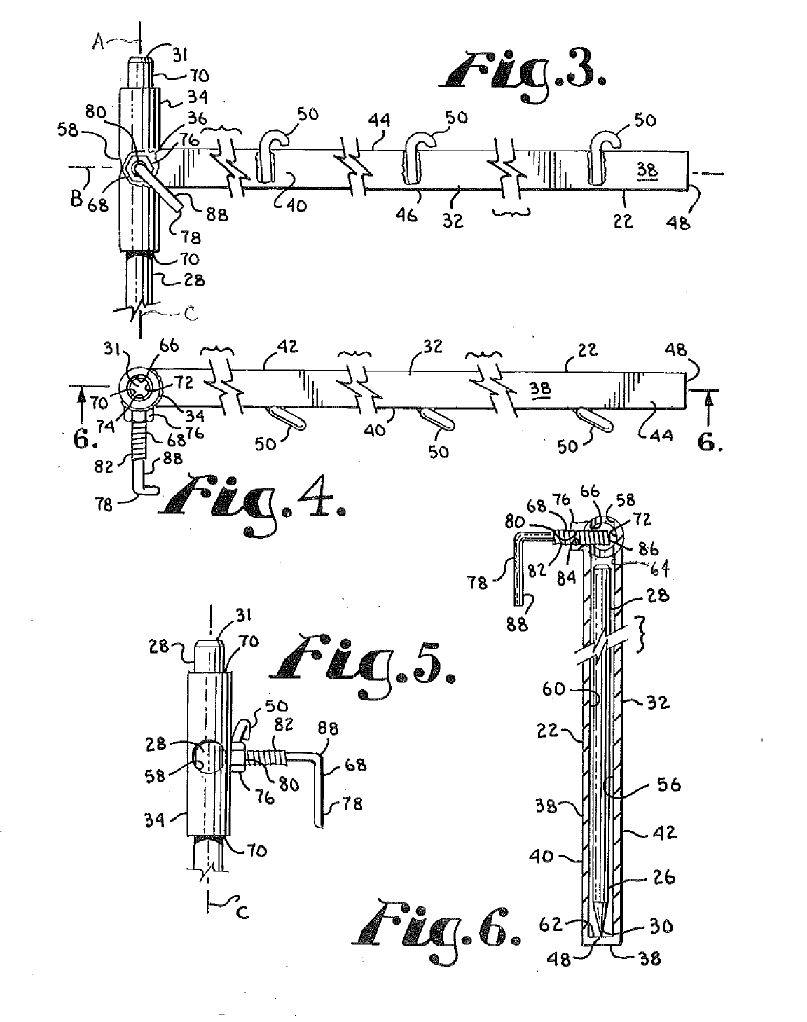

The utensil holding assembly body 32 is elongate and may have a circular, oval, or polygonal cross-section, wherein the cross-section is taken perpendicular to the longitudinal axis B. In the illustrated embodiment, the body 32 has a square cross-section and four sides, including a front side 40, a back side 42, a top side 44 and a bottom side 46. The body also includes a closed end 48 (FIG. 6) that is spaced from and opposed to the neck 36. As shown in FIGS. 3 and 4, one or more utensil holding members or fingers 50 are attached to body front 40, so as to extend above the body top side 44. The fingers 50 are bent or curved so as to form a hook-like structure that can partially wrap around a utensil handle 16. To facilitate grasping the handles 16, the fingers 50 are slanted away from the respective side 40 to which they are attached (see FIGS. 2 and 4).

The top surface 44 of the body 32 and a finger 50 cooperate to engage the utensil handle 16, such as is shown in FIGS. 1 and 2. When engaged or held by the body 32, the handle 16 extends across the body 32, so that the utensil 12 extends and holds the food over the heat source 14 on the ground 24. To prevent the food from falling into the heat source 14, the utensil 12 is balanced on the surface 44 with a handle first portion, generally 52, extending over the heat source 14 and a handle second portion, generally 54, extending away from the heat source 14. In particular, the first and second portions 52, 54 are counter-balanced on the surface 44, so that the first portion 52 presses downwardly on the surface 44, because gravity pulls the food downwardly, thereby causing the second portion 54 to lift upwardly and engage the associated finger 50. The top surface 44, thus, forms a fulcrum or fulcrum surface for the elongated utensil 12, with a finger 50 counterbalancing the weight of the inner portion 52 of the utensil 12 and any food supported thereby.

Referring now to FIG. 6, the body 32 includes an inner stake storage channel 56, or storage chamber or container, which, in the illustrated embodiment, is accessed by an orifice 58 (FIG. 5) in the stake engagement subassembly 34. The storage channel 56 is coaxial with the longitudinal axis B, which passes through the center of the orifice 58. The storage channel 56 includes an inner surface 60 and an inner bottom surface 62, and is sized and shaped to receive the stake 20 therein. In the illustrated embodiment, the storage channel 56 has a square cross-section, taken perpendicular to axis B. However, alternative shapes that are complementary to the stake 20 are foreseen. A top end 64 (FIG. 6) of the storage channel 56 can be closed, as discussed in greater detail below, so as to prevent the stake 20 from falling out of the storage channel 56.

The illustrated stake engagement subassembly 34 is tubular and includes a stake-engaging through-bore 66 and a locking mechanism 68. The through-bore 66 is coaxial with axis C and has a pair of spaced apart openings 70 that are joined by an inner surface 72. The openings 70 are defined by edges 74. The openings 70 and inner surface 72 are complementary in shape to the stake second portion 28.

The through-bore 66 is sized and shaped such that the stake 20 can be passed through both of the openings 70, such as is shown in FIGS. 1, 3, and 5, which allows the stake engagement subassembly 34 to slide along a length of the stake second portion 28. The position or configuration of the utensil holding assembly 22 with respect to the stake 20 can be adjusted by sliding the stake forwards and backwards through the through-bore 66 prior to actuating or locking the locking mechanism 68. Alternatively, the locking mechanism 68 can be locked (see FIG. 6) prior to inserting the stake 20 into the through-bore 66, so that when the stake 20 is inserted through a first of the openings 70 and into the through-bore 66, the stake top 31 contacts the locking mechanism 68 and is prevented from passing through the second of the openings 70 (not shown).

When the stake second portion 28 is received in the through-bore 66, the locking mechanism 68 reversibly engages the stake 20 so that the stake 20 and the utensil holding assembly 22 are locked with respect to one another. When the stake 20 and the utensil holding assembly 22 are locked together, the position of the fork holding assembly 22 relative to the ground 24, or a distance therebetween, is fixed or otherwise set. Accordingly, the utensil holding assembly 22 remains spaced above the ground 24 and heat source 14.

The locking mechanism 68 includes a lock member 76 and a key member 78, which are complementary to one another so as to be reversibly engageable. In the illustrated embodiment, the lock member 76 is a nut or nut-like structure with an inner threaded bore 80 (FIG. 6) that is fixed or fused to the stake engagement subassembly 34 so as to be adjacent to the neck 36. The bore 80 is perpendicular to both of the B and C axes, so that when the key member 78 is received through the bore 80, the key member engages either the stake 20 or the through-bore inner surface 72.

The illustrated key member 78 is a set bolt or set screw with threads 82 that are complementary to threads 84 of the bore 80, so that the key member 78 can be screwed into and out of the lock member 76. The threaded portion 84 of the key member 78 includes a length that is sufficient contact the top 31 of the stake 20, and to thereby prevent the stake 20 from exiting the orifice 58 of the stake engagement subassembly 34 (see FIG. 6) when the stake 20 is stored within the body 32 of the assembly 22. When the stake 20 is inserted through both openings 70 of the through-bore 66 of the stake engagement subassembly 34, the key member 78 can be screwed into the lock member 76, so that the tip 86 of the key member 78 engages and presses against the side of the stake 20, thereby locking the stake 20 in a desired position on the stake engagement subassembly 34. In the illustrated embodiment, the key member 78 includes an L-shaped handle 88 to facilitating turning the key member 78 in the lock member 76. It is foreseen that other forms of complementary locks and keys known in the art may be used in the locking mechanism 68.

When in use, the first end 26 of the stake 20 is driven into the ground 24 next to a heat source 14 by impacting the top 31 of the stake 20 with a hammer, rock, or similar tool. When the stake first end 26 is driven into the ground 24, the second end 28 of the stake 20 extends upwardly from the ground 24 in a generally upright orientation. The stake engagement subassembly 34 is then engaged with the stake second end 28, such as by sliding the stake top 31 through the through-bore 66, such that the stake engagement subassembly 34 is positioned at a desirable location along the length of the stake second portion 28, and such that the stake engagement subassembly 34 is positioned above the ground 24. The stake engagement subassembly 34 is positioned adjacent to the heat source 14 so that the utensil holding assembly 22 extends along the side of the heat source 14. While the utensil holding assembly 22 can be positioned so as to extend over the heat source 14, it is preferred to position utensil holding assembly 22 so that it extends along the side of the heat source 14. Once the stake 20 and the stake engagement subassembly 34 are properly positioned, they are locked relative to one another by locking the locking mechanism 68. Then an utensil 12 is engaged with a finger 50 of the utensil holding assembly 22 such that the utensil 12 is suspended above the ground 24 and extends near or over the heat source 14.

Prior to driving the stake first end 26 in the ground 24, the stake 20 is removed from a storage chamber 56 located within the utensil holding assembly 22. Prior to locking the stake engagement subassembly 34 and stake second end 28, the stake engagement subassembly 34 is slid along a length of the stake second end 28 so as to adjust the position of the utensil holding subassembly 34 with respect to the ground 24.

It is to be understood that while certain forms of the present invention have been illustrated and described herein, it is not to be limited to the specific forms or arrangement of parts described and shown.

1. A utensil holding apparatus for holding a utensil above the ground, the apparatus comprising:
(a) a stake sized and shaped to be driven into the ground such that, when the stake is driven into the ground, an upper portion of the stake extends upwardly from the ground; and
(b) a utensil holding assembly sized and shaped to reversibly engage the stake upper portion so as to be spaced a distance above the ground and to reversibly engage a utensil.

2. The apparatus according to claim 1, wherein the utensil holding assembly includes:
(a) a stake receiving through-bore with an inner surface complementary to the stake upper portion; wherein
(b) the stake upper portion is slidingly engageable with the through-bore inner surface.

3. The apparatus according to claim 2, wherein:
(a) the through-bore inner surface is slidable along a length of the stake upper portion, whereby the distance between the utensil holding assembly and the ground is adjustable.

4. The apparatus according to claim 1, further comprising:
(a) the utensil holding assembly including a locking subassembly sized and shaped for reversibly locking the stake and the utensil holding assembly when the stake and utensil holding assembly are engaged.

5. The apparatus according to claim 4, wherein the locking subassembly includes:
(a) lock member joined with the utensil holding assembly; and
(b) a key member reversibly engageable with the lock member.

6. The apparatus according to claim 1, wherein utensil holding assembly includes:
(a) an inner chamber sized and shaped to reversibly receiving the stake therein; and
(b) at least one utensil engagement member sized and shaped to reversibly engage the utensil.

7. A method of supporting the utensil according to claim 1 above the ground comprising the steps of:
(a) driving a first end of the stake into the ground such that a body of the stake extends upwardly from the ground;
(b) engaging an elongate arm with the stake body such that the arm is positioned above the ground and a utensil engagement portion of the arm is positioned so as to be engageable with the utensil; and
(c) locking the engaged arm and stake body.

8. The method according to claim 7, further comprising the step of:
(a) removing the stake from a storage chamber of the arm prior to the step of driving the stake first end in the ground.

9. The method according to claim 7, further comprising the step of:
(a) sliding the arm along a length of the stake body so as to adjust the position of the arm above the ground prior to the step of locking the engaged arm and stake body.

10. A utensil holding apparatus for positioning an elongated cooking utensil above a heat source and comprising:
(a) an elongated stake member adapted being driving substantially vertically into ground;
(b) a utensil supporting arm engaging the stake to be supported substantially parallel to the ground, the arm forming a fulcrum to be engaged by an elongated cooking utensil; and
(c) a utensil holding member attached to the arm in such a manner as to releasably engage an elongated cooking utensil positioned on the arm to thereby counterbalance a weight of a portion of the utensil extending from the arm on the fulcrum thereof to thereby positively position the elongated cooking utensil above a heat source.

11. An apparatus as set forth in claim 10 and including:
(a) a tubular attachment member positioned at an end of the utensil supporting arm;
(b) the attachment member receiving the stake member therethrough: and
(c) a locking mechanism releasably engaged between the attachment member and the stake to selectively position the arm along the stake.

12. An apparatus as set forth in claim 11 wherein:
(a) the utensil supporting arm has a storage chamber therein to receive and store the stake; and
(b) the locking mechanism is engaged with the attachment member in such a manner as to releasably retain the stake within the storage chamber of the arm.

13. An apparatus as set forth in claim 10 wherein:
(a) the utensil holding member is attached to the arm in such a manner as to position a supported cooking utensil at a selected angle to the arm.

14. An apparatus as set forth in claim 10 and including:
(a) a plurality of utensil holding members attached in spaced relation along the arm; and
(b) the utensil holding members are attached to the arm at varying angles to the arm.

15. An apparatus as set forth in claim 10 wherein:
(a) the utensil holding arm has a front surface on an opposite side of a heat source; and
(b) the utensil holding member is attached to the arm on the front surface thereof.

16. An apparatus as set forth in claim 10 wherein:
(a) the utensil holding member is a hook shaped finger having a downwardly open curved portion to be engaged by a cooking utensil supported by the arm.
